(19) United States
(12) Patent Application Publication
(10) Pub. No.: US 2017/0169822 A1
(43) Pub. Date: Jun. 15, 2017

(54) DIALOG TEXT SUMMARIZATION DEVICE AND METHOD

(71) Applicant: HITACHI, LTD., Tokyo (JP)

(72) Inventor: Yusuke Fujita, Tokyo (JP)

(73) Assignee: HITACHI, LTD., Tokyo (JP)

(21) Appl. No.: 15/365,147

(22) Filed: Nov. 30, 2016

(30) Foreign Application Priority Data
Dec. 14, 2015 (JP) 2015-243243

(51) Int. Cl. G10L 15/22; G10L 17/06; G10L 15/19; G10L 15/16

(52) U.S. Cl. CPC G10L 15/22; G10L 15/16; G10L 17/06; G10L 15/19; H04M 2203/40

(57) ABSTRACT

Provided is a summarization technology for correcting a dialog text on a word-by-word basis for readability using a dialog structure. A dialog text summarization device includes: a recognition result acquisition unit that acquires, from a database, a word recognized from a dialog form text, time-series information of the word, and identification information identifying a speaker of the word; and a text summarization unit that corrects the word based on the word, the time-series information of the word, the identification information, and a summarization model, and that outputs a correction result to the database.

### CLAIM OF PRIORITY

The present application claims priority from Japanese patent application JP 2015-243243 filed on Dec. 14, 2015, the content of which is hereby incorporated by reference into this application.

### BACKGROUND

Technical Field

The present invention relates to a technology for automatically summarizing a text or message in dialog form (hereafter referred to as “dialog form text” or “dialog text”).

Background Art

At many of call centers that handle inquiries and the like from customers, the content of a call between an operator and a customer is recorded in a call recording device. Today, the volume of voice information being recorded in the call recording database is increasing yearly. To improve the quality and efficiency of the call center operations, attempts have been made to automatically convert the recorded voice information into text.

However, the data obtained by automatic conversion into text are often hard to read for humans. This is mainly due to the fact that the recognition accuracy is insufficient, and that it is difficult to only summarize important portions and create text.

The Abstract of Patent Document 1 describes a dialog summarization system thus: “A dialog summarization system 1 for extracting one or more important sentences from a dialog content and generating summarized data is provided with an important sentence extraction unit 13 which, based on dialog structure data 14 including information about each statement in the dialog content, information about a score indicating the degree of importance of each statement, and information about blocks in units of successive statements of each speaker, extracts the highest-score statement from the dialog structure data 14 as an important sentence until predetermined summarization conditions are satisfied; allocates predetermined scores to a first block from which the important sentence has been extracted and a second block around the first block; and allocates predetermined scores to the score of each statement included in the first and second blocks in accordance with a predetermined condition and sums the scores”. In the following, this technology will be referred to as “conventional method”.

### RELATED ART DOCUMENTS

### Patent Documents

Patent Document 1: JP-2013-120514 A

### SUMMARY

As described above, the conventional method is a technique whereby the degree of importance is determined on a passage unit (block unit) basis for summarization, where the determination of the degree of importance on a word-by-word basis is not contemplated. In addition, the conventional method, even if the degree of importance can be determined on a word-by-word basis, does not contemplate determining the degree of importance on a word-by-word basis based on the structure of dialog.

The inventor considers that a function for determining the degree of importance on a word-by-word basis based on the dialog structure will be useful when, for example, summarizing a text in the following situations:

Situation 1: Chiming-in while the counterpart is talking.

Chiming-in in such situation has a low degree of importance and may be deleted for readability of text.

Situation 2: Chiming-in or replying utterance in response to a counterpart's utterance.

Such chiming-in or replying utterance has a high degree of importance and should be actively left.

Situation 3: Operator's utterance immediately before the customer's saying “I see”.

Such utterance has a high degree of importance and should actively be left.

Situation 4: Utterance, though including an important word, having recognition error.

If an error on the customer's part is repeated and corrected by the operator, the erroneous utterance may be deleted for readability of text.

Accordingly, the present inventor provides a summarization technology for correcting a dialog text on a word-by-word basis for readability by utilizing dialog structure.

In order to solve the problem, the present invention adopts the configurations set forth in the claims. The present specification includes a plurality of means for solving the problem, of which one example is a dialog text summarization device which includes a recognition result acquisition unit that acquires, from a database, a word recognized from a dialog form text, time-series information of the word, and identification information identifying a speaker of the word; and a text summarization unit that corrects the word based on the word, the time-series information of the word, the identification information, and a summarization model, and that outputs a correction result to the database.

According to the present invention, an easy-to-read summary in which the dialog form text has been automatically corrected on a word-by-word basis can be created. Other problems, configurations, and effects will become apparent from the following description of embodiments.

### BRIEF DESCRIPTION OF THE DRAWINGS

FIG. 1 is a block diagram of a system configuration of the first embodiment. FIG. 2 is a flowchart of the outline of a text summarization operation.

FIG. 3 is an example of the data structure of a call recording DB.

FIG. 4 is an example of the data structure of a call recognition result DB.

FIG. 5 shows examples of word correction by a text summarization unit.

FIG. 6 illustrates an example of the structure of a summarization model.

FIG. 7 is a flowchart of a call visualization operation.

FIG. 8 illustrates an example of a display in a case where summary display has been selected on a result display screen.

FIG. 9 illustrates an example of a display in a case where summary display has not been selected on the result display screen.

FIG. 10 is a block diagram of a system configuration according to the second embodiment.

FIG. 11 describes a text summarization operation according to the second embodiment.

### DETAILED DESCRIPTION

In the following, embodiments of the present invention will be described with reference to the drawings. It should be noted that the mode of the present invention is not limited to the embodiments that will be described below, and that various modifications may be made within the technical scope of the invention.

### (1) First Embodiment

### (1-1) System Configuration

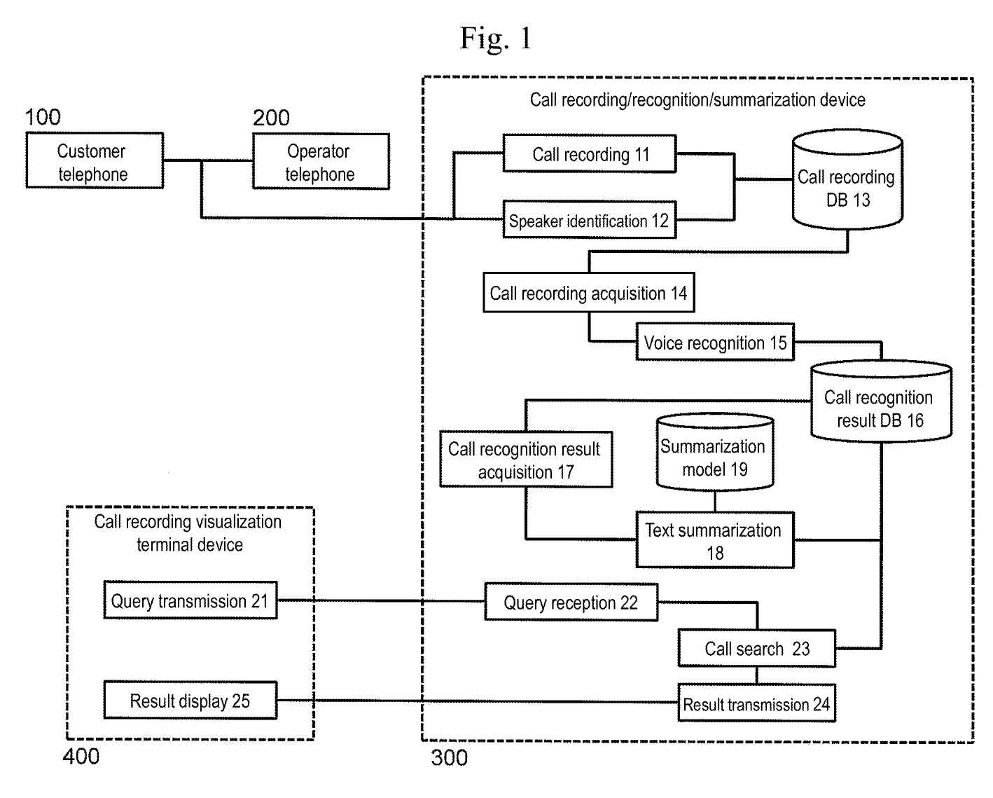

FIG. 1 illustrates an overall configuration of a call recording/recognition/summarization system according to the present embodiment. The system includes a customer telephone 100; an operator telephone 200; a call recording/recognition/summarization device 300; and a call recording visualization terminal device 400. The customer telephone 100 is a telephone used by a customer, and may be a fixed telephone, a portable telephone, or a smartphone, for example. The operator telephone 200 is a telephone used by an operator at a call center. While FIG. 1 illustrates a single customer telephone 100 and a single operator telephone 200, this is by way of example, and there may be a plurality of the respective telephones.

The call recording/recognition/summarization device 300 provides a function for automatically converting voice information exchanged between the operator and the customer into text; a function for automatically creating a summary of the dialog text created by the conversion into text; and a function for providing the summary of the dialog text in accordance with a request. In many cases, the call recording/recognition/summarization device 300 may be implemented as a server. For example, of the constituent elements of the call recording/recognition/summarization device 300, the functional units other than the databases are implemented by programs executed on a computer (including, e.g., a CPU, a RAM, and a ROM).

The call recording visualization terminal device 400 is a terminal which is used when visualizing a summarized dialog text. The call recording visualization terminal device 400 may be any terminal that includes a monitor; examples are a desktop computer, a laptop computer, and a smartphone. While in FIG. 1 a single call recording visualization terminal device 400 is illustrated, this is by way of example, and there may be a plurality of call recording visualization terminal devices.

In the present embodiment, the operator telephone 200, the call recording/recognition/summarization device 300, and the call recording visualization terminal device 400 are disposed in a single call center. However, the constituent elements of the operator telephone 200, the call recording/recognition/summarization device 300, and the call recording visualization terminal device 400 may not necessarily be all present in a single call center; instead, they may be distributed at a plurality of locations or, among a plurality of business operators in other embodiments.

The call recording/recognition/summarization device 300 is provided with a call recording unit 11; a speaker identification unit 12; a call recording DB 13; a call recording acquisition unit 14; a voice recognition unit 15; a call recognition result DB 16; a call recognition result acquisition unit 17; a text summarization unit 18; a summarization model 19; a query reception unit 22; a call search unit 23; and a result transmission unit 24. FIG. 1 contemplates the case in which all of the functional units of the call recording/recognition/summarization device 300 are under the management of a single business operator.

The call recording unit 11 acquires voices (calls) transmitted and received between the customer telephone 100 and the operator telephone 200, and creates a voice file for each call. The call recording unit 11 implements the corresponding function using a known recording system based on, e.g., IP phone. The call recording unit 11 manages the individual voice files by associating them with recording times, extension numbers, telephone numbers of the other party and the like. The speaker identification unit 12 identifies the speaker of the voice (whether the speaker is a sender or a recipient) by utilizing the association information. That is, the speaker identification unit 12 identifies whether the speaker is an operator or a customer. The call recording unit 11 and the speaker identification unit 12 create a sender-side voice file and a receiver-side voice file from one call, and saves the files in the call recording database (DB) 13. The call recording DB 13 is a large-capacity storage device or system with a recording medium such as a hard disk, an optical disk, or a magnetic tape. The call recording DB 13 may be configured as a direct-attached storage (DAS), a network-attached storage (NAS), or a storage area network (SAN), for example.

The call recording acquisition unit 14 reads the voice files (sender voice file and receiver voice file) from the call recording DB 13 for each call, and feeds the files to the voice recognition unit 15. The reading of the voice files is executed during a call (in real-time), or at an arbitrary timing after the end of a call. In the present embodiment, the reading of the voice files is contemplated to be executed during a call (in real-time). The voice recognition unit 15 subjects the contents of the two voice files to voice recognition for conversion into text information. For voice recognition, a known technology may be used. However, in light of a summarization process which will be executed in a later stage, a voice recognition technology capable of outputting the text information on a word-by-word basis and chronologically may be desirable. The result of voice recognition is registered in the call recognition result DB 16. The call recognition result DB 16 is also a large-capacity storage device or system, and implemented as a medium or in a form similar to the call recording DB 13. The call recording DB 13 and the call recognition result DB 16 may be managed as different store regions of the same storage device or system.

The call recognition result acquisition unit 17 acquires, from the call recognition result DB 16, the call recognition results associated with the recording ID, and sorts the results in the chronological order of appearance of words. By the sorting, a time-series of words to which a speaker ID is given with respect to one recording ID is obtained. The text summarization unit 18, when given the input of the time-series of words created by the call recognition result acquisition unit 17, summarizes the text on a word-by-word basis by applying the summarization model 19. In the case of the present embodiment, a recurrent neural network is contemplated as the summarization model 19. The summarization by the text summarization unit 18 involves a word-by-word correction process. Word-by-word correction information is fed back from the text summarization unit 18 to the call recognition result DB 16. As a result, in the call recognition result DB 16, the aforementioned time-series of words given the speaker ID with respect to one recording ID is stored while being associated with the word-by-word correction information.

The query reception unit 22 executes a process for which a query is received from the call recording visualization terminal device 400. The query may include the presence or absence of execution of summary display, for example, in addition to a recording ID. Based on the recording ID identified by the query, the call search unit 23 reads the time-series of words for each speaker from the call recognition result DB 16. The result transmission unit 24 transmits the time-series of words for each speaker that has been read to the call recording visualization terminal device 400.

The call recording visualization terminal device 400 includes a query transmission unit 21 that receives the input of a query, and a result display unit 25 that visualizes the dialog text. The call recording visualization terminal device 400 includes a monitor, and the input of query and the displaying of a dialog text are executed via an interface screen displayed on the screen of the monitor.

### (1-2) Text Summarization Operation

FIG. 2 shows the outline of the text summarization operation executed by the call recording/recognition/summarization device 300. First, the call recording unit 11 acquires a voice (call) transmitted and received between the customer telephone 100 and the operator telephone 200, and creates a voice file for each call (step S201). As described above, the voice file is associated with recording time, extension number, the telephone number of the other party and the like. The speaker identification unit 12, utilizing the association information, identifies the speaker of the voice (whether the speaker is a sender or a receiver) (step S202). The call recording unit 11 and the speaker identification unit 12 create a sender-side voice file and a receiver-side voice file from a single call, and save the files in the call recording DB 13 (step S203).

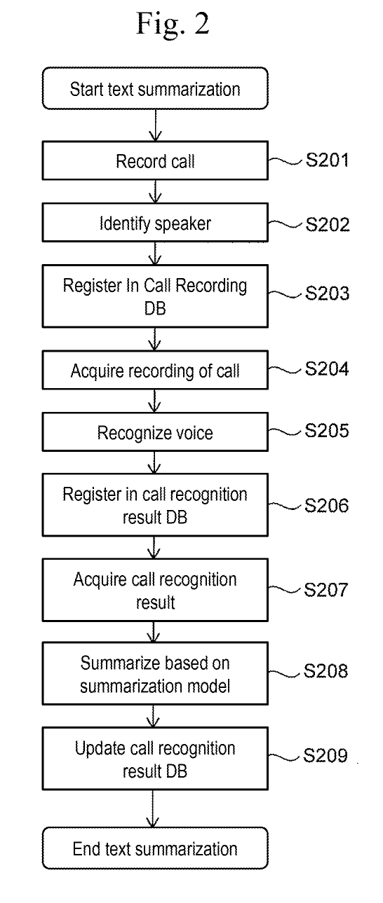

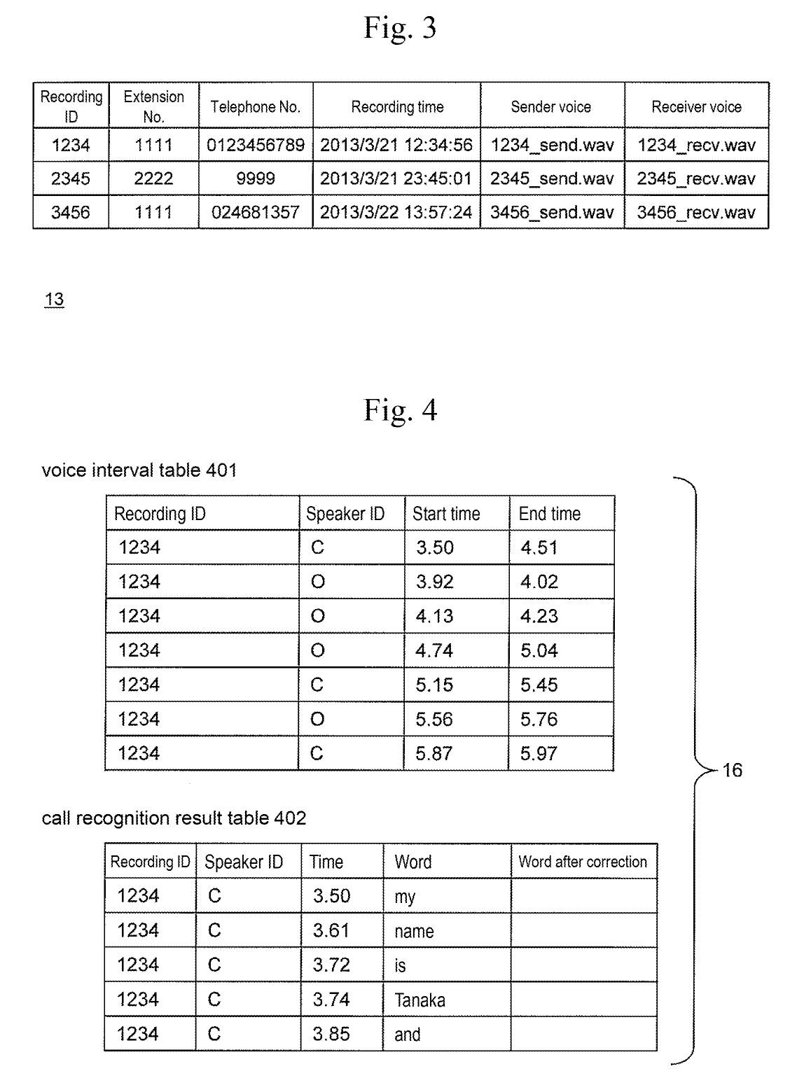

FIG. 3 shows an example of the data structure of the call recording DB 13. In the call recording DB 13, there is recorded information such as, with respect to each call, recording ID, extension number, telephone number, recording time, file name, and the path of each file. The operator telephone 200 is identified by the extension number, and the customer telephone 100 is identified by the telephone number.

Referring back to FIG. 2, the call recording acquisition unit 14 then acquires from the call recording DB 13 two voice files as the recorded voice files, and feeds them to the voice recognition unit 15 (step S204). The voice recognition unit 15 converts the content of the two voice files into text information using voice recognition technology (step S205). In addition, the voice recognition unit 15 registers the text information as the voice recognition result in the call recognition result DB 16 on a word-by-word basis (step S206).

FIG. 4 shows an example of the data structure of the call recognition result DB 16. The call recognition result DB 16 is provided with a voice interval table 401 and a call recognition result table 402. In the voice interval table 401, there are recorded the recording ID of the call recording DB 13; the speaker ID (in the present embodiment, “O” indicates the transmission side, and “C” indicates the reception side); and the start time and end time of the voice interval. The voice interval herein is recorded in units corresponding to the start and end of a breath group detected as the result of processing of the voice file by the voice recognition unit 15. In the call recognition result table 402, there is recorded recording ID, speaker ID, word, and the time of appearance of the word. When information is being recorded by the voice recognition unit 15, the column for the word after correction is blank.

Referring back to FIG. 2, the call recognition result acquisition unit 17 then acquires from the call recognition result DB 16 the call recognition result (step S207). Specifically, the call recognition result acquisition unit 17 acquires the call recognition result associated with the recording ID for a new recording, from the call recognition result table 402, and sorts the acquired words in the chronological order of appearance. By the sorting, a time-series of words where a speaker ID is provided to one recording ID is obtained. The obtained time-series of words is input to the text summarization unit 18. The text summarization unit 18, upon reception of the time-series of words, summarizes the text on a word-by-word basis by applying the summarization model 19 (step S208).

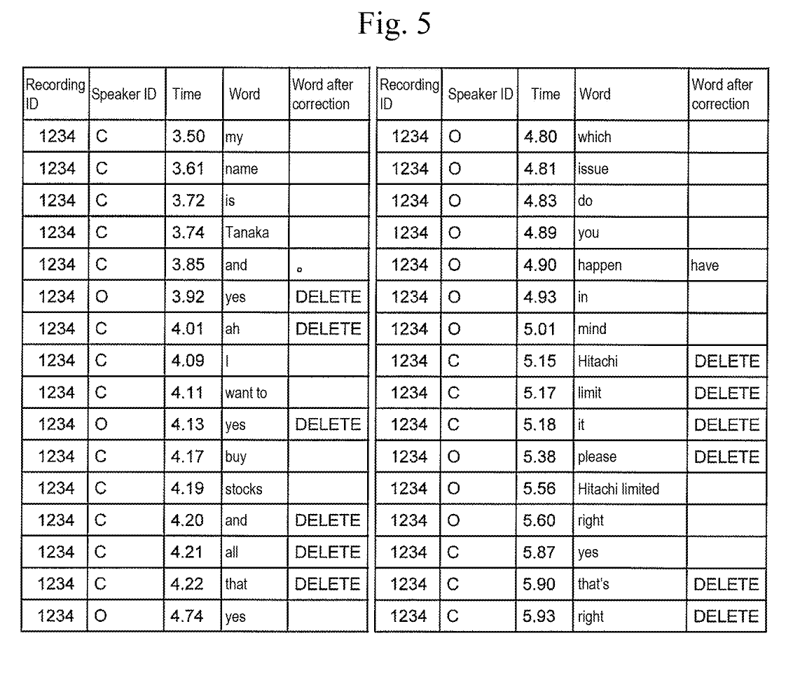

FIG. 5 shows examples of word correction by the text summarization unit 18. The text summarization unit 18 evaluates the need for correction on a word by word basis, and outputs the result. For example, the text summarization unit 18 outputs a corrected word if correction is needed; outputs “DELETE” if deletion is needed; and outputs a blank or a specific code or the like if correction is not needed. In FIG. 5, the absence of need for correction is indicated by a blank.

As shown in FIG. 5, even for the same word “Yes”, the word is deleted if the word is considered a chiming-in made by the operator (speaker ID: “O”) while the customer (speaker ID: “C”) was making an utterance; the word is left if it is considered a chiming-in after the end of the counterpart's utterance. In addition, words that interfere with readability, such as “Ah,” or “that's right” that follows “Yes”, are deleted. Based on a determination of the context, “happen” may be corrected to “have”. Further, of the customer's utterances, text determined to be a recognition error (such as “Hitachi-limit-it”) is deleted. In this way, in the present embodiment, word-by-word deletion and correction are performed based on the speaker ID and the time-series context, so as to increase the recognition result readability.

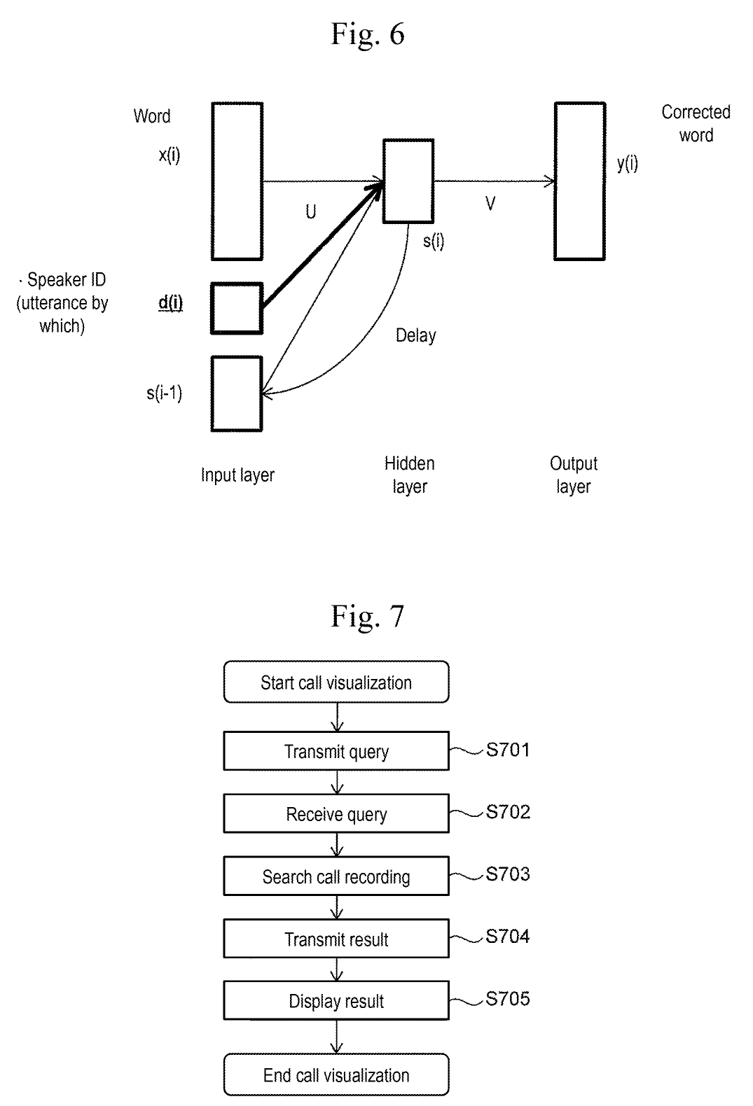

In the present embodiment, the summarization model 19 uses a recurrent neural network. FIG. 6 illustrates a configuration example of the recurrent neural network. In the following, the outline of a process by the recurrent neural network will be described with reference to FIG. 6. To the input layer, a vector x(i) representing the i-th word and a value d(i) representing the speaker ID are fed. An output s(i) of the hidden layer is expressed by the following expression using an output s(i-1) of the i-1-th hidden layer, the vector x(i) representing the i-th word fed to the input layer, d(i) representing the speaker ID similarly fed to the input layer, an input weight matrix U, and a sigmoid function σ(.):

s(i)=σ(U[x(i)d(i)s(i−i)]) (Expression 1)

An output y(i) of the output layer is expressed by the following expression using the output s(i) of the hidden layer, the output weight matrix V, and a softmax function softmax

y(i)=softmax(Vs(i)) (Expression 2)

The output y(i) thus computed is considered the vector representing the word after correction of the i-th word. In this case, the input weight matrix U and the output weight matrix V are determined by training in advance. Such training can be implemented using the process of back propagation through time, for example, given a number of correct solutions to input/output relationship. In this case, by creating the correct solutions to the input/output relationship using a word sequence as the voice recognition result and a word sequence as a result of human summarization thereof, an appropriate summarization model can be created. In reality, such correct solutions may include deletion of redundant words, correction of recognition error words, deletion of unwanted sentences and the like in light of context. In the summarization model based on a recurrent neural network, these can be operated in the same framework.

For the summarization model 19, it is also possible to adopt mechanisms other than the above-described recurrent neural network. For example, a rule-based mechanism may be adopted in which correction or deletion is designated when a word of concern, words appearing before and after the word of concern, and their respective speaker IDs match a predetermined condition. The summarization model 19 may not be based on a method that takes a time-series history into consideration, as in the recurrent neural network. For example, for determining whether a word is to be deleted, an identification model such as a conditional random field based on feature quantities composed of the preceding or following words and the speaker IDs may be used.

### (1-3) Call Visualization Operation

FIG. 7 illustrates a series of operations that are executed during call visualization. The call visualization operation is started at the call recording visualization terminal device 400 as the starting point. First, the query transmission unit 21 transmits a desired recording ID received via the interface screen to the call recording/recognition/summarization device 300 as a query (step S701). The recording ID is assumed to be acquired in advance by a separate technique, such as accessing the call recording DB 13, and then presented to the user in a selectable manner.

The query reception unit 22 receives and feeds the query transmitted from the query transmission unit 21 to the call search unit 23 (step S702). The call search unit 23, based on the recording ID included in the query received by the query reception unit 22, searches the call recognition result DB 16 to access the corresponding voice interval information and recognition result information (step S703). In this case, the voice interval table 401 and the call recognition result table 402 are both output to the result transmission unit 24 as search results. The result transmission unit 24 transmits the search results output from the call search unit 23 to the call recording visualization terminal device 400 (step S704). The result display unit 25 displays the received search results on the monitor (S705).

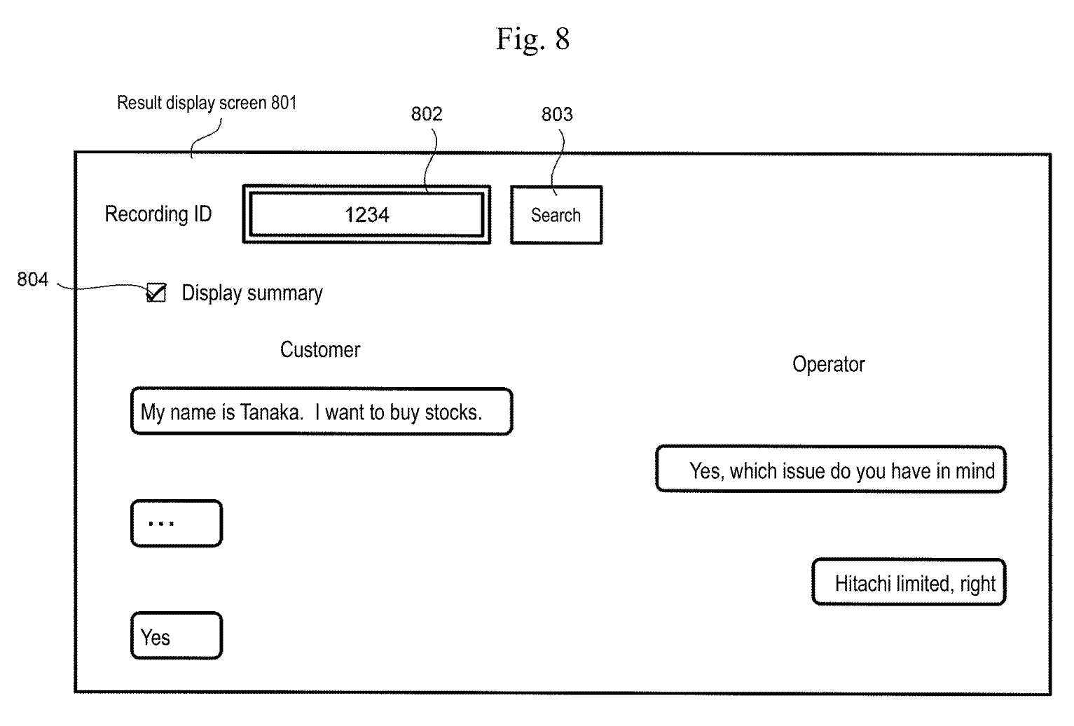

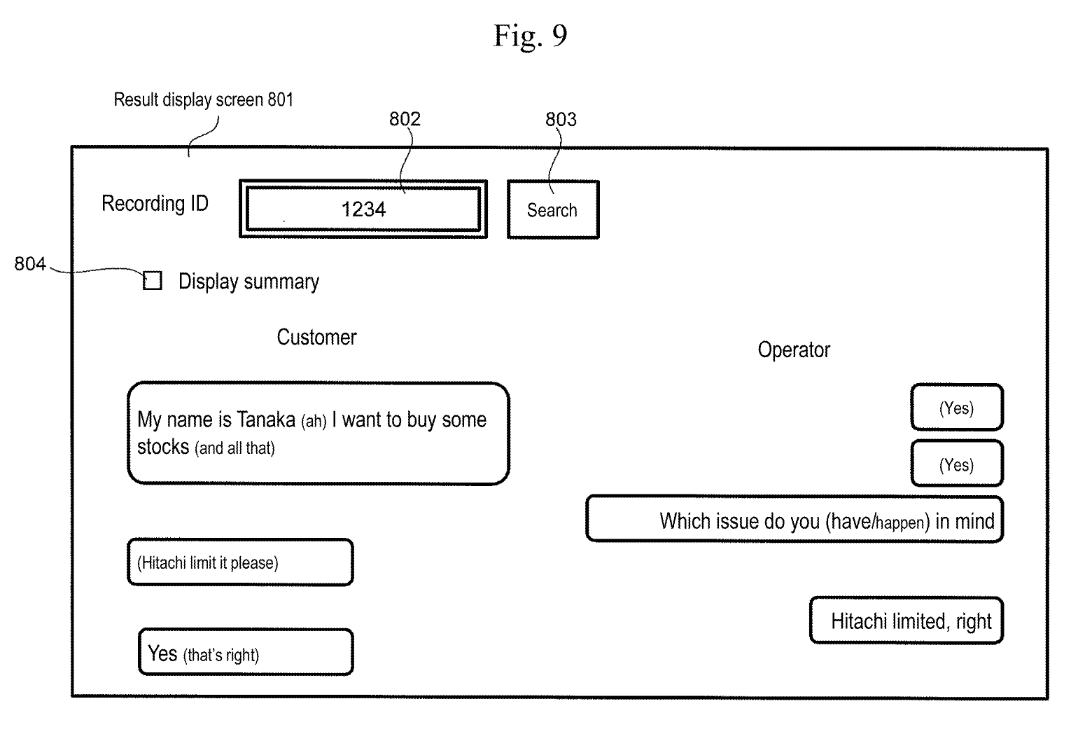

FIG. 8 illustrates an example of a result display screen 801. In a recording ID column 802, the retrieved recording ID is displayed. The recording ID column 802 is also used for the input of the recording ID when accepting the query. When a search button 803 is clicked on the screen, a query of which a part is composed of the recording ID input in the recording ID column 802 is transmitted to the call recording/recognition/summarization device 300. A summary display check box column 804 is used for selecting summary display. In FIG. 8, the summary display check box column 804 is checked. In this case, the result display unit 25 displays a dialog text reflecting the correction result. This display is the summary display.

The result display unit 25, based on the search result, initially arranges a rectangle indicating the voice interval of the customer (speaker ID: “C”) on the left side, and arranges a rectangle indicating the voice interval of the operator (speaker ID: “O”) on the right side. In each rectangle, the words uttered in the same voice interval are arranged in order. When the words are arranged in the rectangle, if the word after correction is “DELETE”, the result display unit 25 does not display the corresponding word. If the word after correction is other than blank, the result display unit 25 displays the word after correction instead of the corresponding word.

If there is no word in the voice interval after correction, or if a word is entirely included in the counterpart's voice interval, the word could be considered a chiming-in. Accordingly, the result display unit 25 deletes the rectangle itself. If a word is not included in the counterpart's voice interval, it may be considered the result of deletion of a recognition error. Accordingly, the result display unit 25 substitutes a display, such as “. . . ”, meaning that there was an utterance which could not be recognized. The rectangles are displayed at different heights (rows) in the order of time. In this way, a summary is presented on a word-by-word basis, whereby an easy-to-read display can be obtained. The presence of correction may be indicated by, for example, highlighting the corresponding text, changing the size of font, changing the color of font, or adding other modifications. The display content of the result display screen 801 or its layout may be created by the result transmission unit 24 and transmitted to the result display unit 25.

FIG. 9 illustrates an example where the summary display check box column 804 is not checked; i.e., when the search result is not displayed as a summary. In this case, it is possible to display the original sentence before text summarization. However, in the example of FIG. 9, the display is made in such a manner that the content of the correction result can be confirmed. For example, a word group corresponding to “DELETE” by summarization is placed in parentheses and then displayed in small letters. By adopting such notation, the user can read the corresponding passage portion when necessary or simply skip the portion when not necessary. In addition, by displaying the words before and after correction in parentheses, and additionally displaying the words before correction in small letters, it can be clearly seen what correction has been made. Such display is mainly effective when evaluation is made while listening to the voice as a whole. For example, the display is effective in a case where it is desired to start playback from around a word that has been deleted by summarization. FIG. 8 and FIG. 9 may be displayed on the same screen side by side.

### (1-4) Effects of Embodiment

As described above, in the call recording/recognition/summarization system according to the present embodiment, it is possible, after a dialog text is divided into word levels, to create a summary in which the text is corrected on a word-by-word basis by utilizing the structure of the dialog of the recording of a call (specifically, the information identifying the speaker of each word and the information about the time-series of words). Accordingly, a dialog text summary that is easy to read compared with one by conventional methods can be created.

For example, text of a chiming-in made while the counterpart is talking, or text containing recognition error can be deleted. On the other hand, utterances having a high degree of importance, such as a chiming-in or a reply in response to the counterpart's utterance, or the operator's utterance immediately before the customer's utterance “I see”, can be actively left. As a result, an easy-to-read summary can be created while leaving words with high degree of importance. In addition, the present embodiment makes it possible to select whether a summary is to be displayed, so that the summarized content can be confirmed as needed.

### (2) Second Embodiment

The first embodiment has been described with reference to the case where voice recognition and summarization processes are implemented simultaneously with recording of a call within a single device. In the present embodiment, a call recording/recognition/summarization system will be described in which voice recognition and summarization processes for recording of a call that are required in accordance with a request from the user are executed, and the result is visualized.

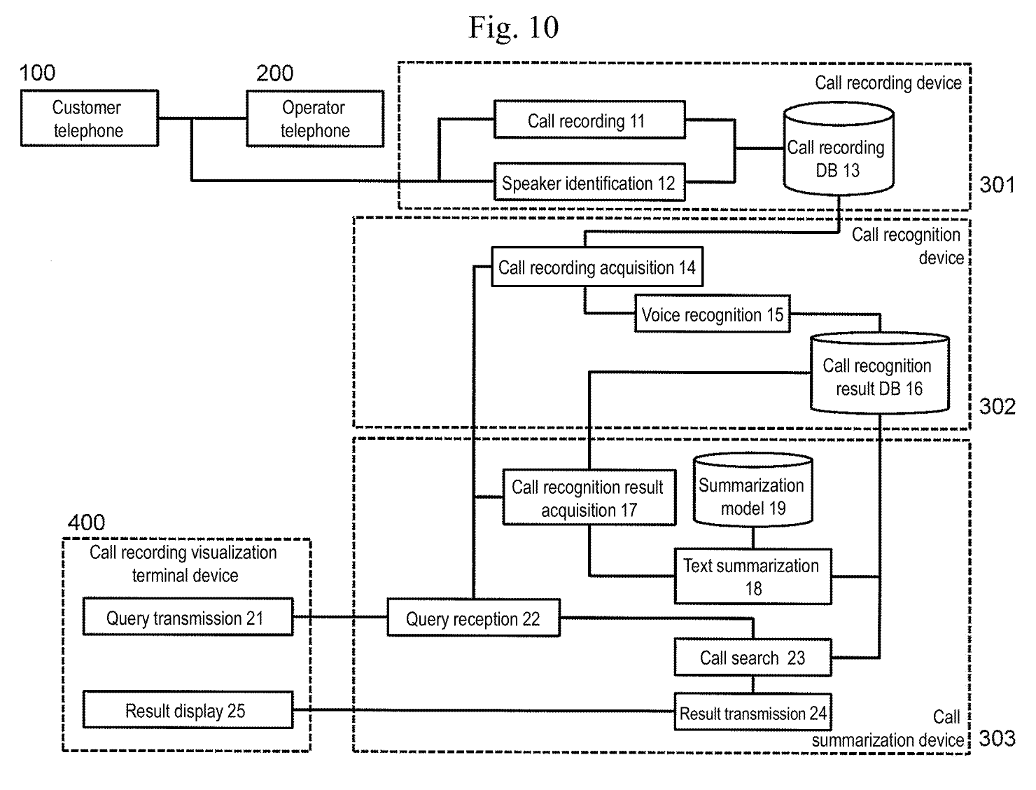

FIG. 10 illustrates the overall configuration of the call recording/recognition/summarization system according to the present embodiment . In the case of this system, a call recording/recognition/summarization device 300 is divided into a call recording device 301, a call recognition device 302, and a call summarization device 303. The call recording device 301 is provided with a call recording unit 11, a speaker identification unit 12, and a call recording DB 13. The call recognition device 302 is provided with a call recording acquisition unit 14, a voice recognition unit 15, and a call recognition result DB 16. The call summarization device 303 is provided with a call recognition result acquisition unit 17, a text summarization unit 18, a summarization model 19, a query reception unit 22, a call search unit 23, and a result transmission unit 24. The call recording device 301, the call recognition device 302, and the call summarization device 303 may be disposed at the same location, or may be distributed at a plurality of locations. The call recording device 301, the call recognition device 302, and the call summarization device 303 may be each managed and operated by different business operators.

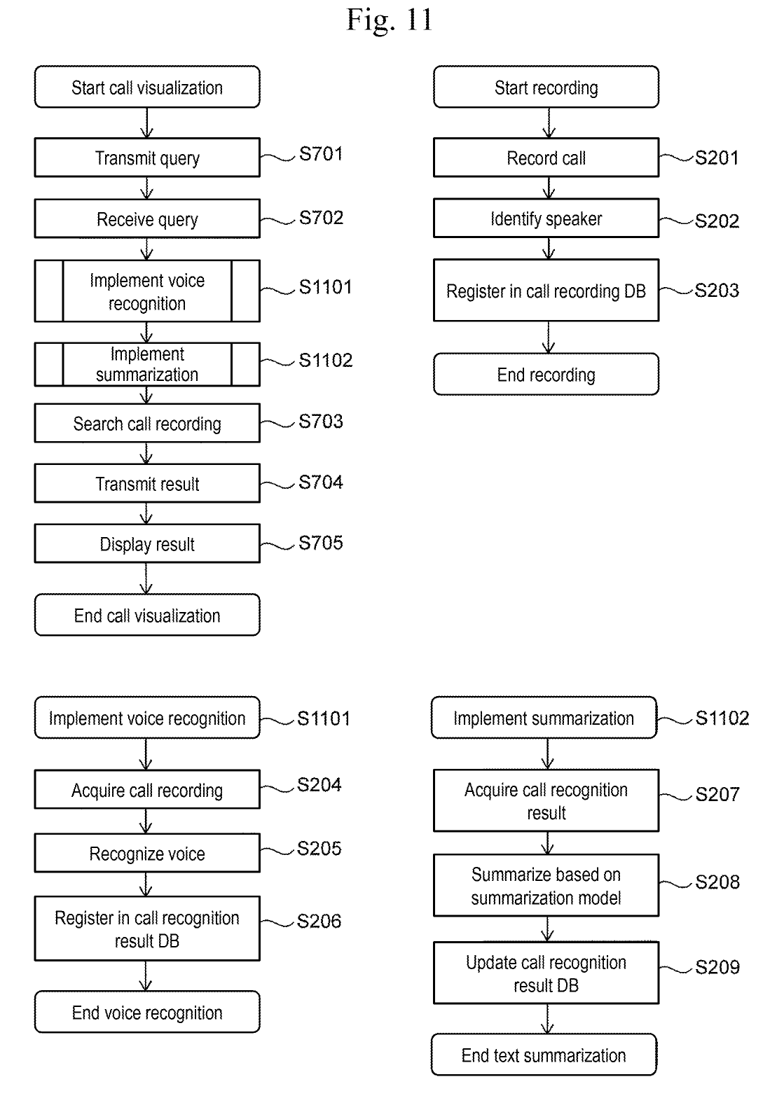

FIG. 11 describes a text summarization operation according to the present embodiment. As illustrated in FIG. 11, the text summarization operation includes a recording operation and a call visualization operation (voice recognition operation, summarization operation). That is, in the present embodiment, after a query for call visualization is received, voice recognition (step S1101) and summarization (step S1102) are executed. Accordingly, the process of steps S204 to S209 of FIG. 2 is executed in the call visualization operation. The content of operation executed in the individual operation steps is equivalent to that according to the first embodiment.

In the present embodiment, the voice recognition operation S1101 is not executed for all of the recording IDs but only executed with respect to the recording ID included in the query received in the call visualization operation. The same applies to the summarization operation S1102 which is executed after the end of the voice recognition operation. The above configuration makes it possible to perform voice recognition only on the necessary recording designated by the user for summarization and visualization. Accordingly, computing resources can be effectively utilized.

In the present embodiment, the voice recognition operation and the summarization operation are executed as part of the call visualization operation. However, only the summarization operation may be executed as part of the call visualization operation. In this case, the voice recognition operation may be executed, as in the first embodiment, at the time of recording of a call between customer and operator, or at least before the start of the call visualization operation. Adopting such operation technique also makes it possible to effectively utilize computing resources.

### (3) Other Embodiments

The present invention is not limited to the above-described embodiments and may include various modifications. For example, while the embodiments presented systems for visualizing voices of a call, the present invention is not limited to voice and may be widely applied for a search of data including dialog. For example, similar summarization can be performed for text chatting and the like, based on the text content and a message transmission time sequence. The object of the present invention is not limited to a dialog between two persons, and may include the speaker IDs of three or more persons. Accordingly, the present invention can be applied to a dialog among three or more persons, such as a in a teleconference system.

The present invention is not necessarily required to be equipped with all of the configurations described with reference to the embodiments. Part of the configuration of one embodiment may be substituted by the configuration of another embodiment, or the configuration of the other embodiment may be incorporated into the configuration of the one embodiment. Other constituent elements may be incorporated into the respective embodiments, or some constituent elements of one embodiment may be replaced with other constituent elements.

The configurations, functions, processing units, processing means and the like described above may be partly or entirely designed for integrated circuitry and implemented by hardware. For example, the various functions for recording, recognition, and summarization of a call that are implemented by a program executed on the CPU of a server may be partly or entirely implemented by hardware using electronic components, such as integrate circuits.

The information of the programs, tables, files and the like for implementing the respective functions may be stored in a storage device, such as a memory, a hard disk, or a solid state drive (SSD), or in a storage medium, such as an IC card, an SD card, or a DVD. The illustrated control lines and information lines are only those considered necessary for the purpose of description, and do not represent all of the control lines and information lines that may be required in a product. In practice, almost all of the configurations may be considered to be mutually connected.

### DESCRIPTION OF SYMBOLS

11 Call recording unit
12 Speaker identification unit
13 Call recording DB
14 Call recording acquisition unit
15 Voice recognition unit
16 Call recognition result DB
17 Call recognition result acquisition unit
18 Text summarization unit
19 Summarization model
21 Query transmission unit
22 Query reception unit
23 Call search unit
24 Result transmission unit
25 Result display unit
100 Customer telephone
200 Operator telephone
300 Call recording/recognition/summarization device
301 Call recording device
302 Call recognition device
303 Call summarization device
400 Call recording visualization terminal device

What is claimed is:

1. A dialog text summarization device comprising:
a recognition result acquisition unit that acquires, from a first database, a word recognized from a dialog form text, time-series information of the word, and identification information identifying a speaker of the word; and
a text summarization unit that corrects the word based on the word, the time-series information of the word, the identification information, and a summarization model, and that outputs a correction result to the first database.

2. The text summarization device according to claim 1, wherein the text summarization unit deletes a word determined to be not important by a determination using the summarization model.

3. The dialog text summarization device according to claim 1, wherein the text summarization unit deletes a word determined to be a recognition error by a determination using the summarization model.

4. The dialog text summarization device according to claim 1, wherein the text summarization unit corrects the word using a recurrent neural network in the summarization model.

5. The dialog text summarization device according to claim 1, further comprising a result display unit that displays the dialog form text including the correction result in such a manner that a corrected portion and/or a corrected content can be confirmed.

6. The dialog text summarization device according to claim 1, further comprising a result display unit that displays the dialog form text reflecting the correction result and the dialog form text including the correction result side by side.

7. The dialog text summarization device according to claim 1, further comprising a recognition unit that executes a process of recognizing a word included in the dialog form text, a process of managing the time-series information for each of the recognized word, and a process of managing the identification information identifying the speaker of the word as a recognition process.

8. The dialog text summarization device according to claim 7, wherein:
the recognition unit, after receiving a query designating the dialog form text from an external terminal, acquires the dialog form text designated by the query from a second database and executes the recognition process, and further stores a process result in the first database; and
the recognition result acquisition unit, after a recognition result is obtained from the recognition unit, outputs the word concerning the dialog form text designated by the query, the time-series information of the word, and the identification information to the text summarization unit.

9. The dialog text summarization device according to claim 7, wherein the recognition result acquisition unit, after receiving the query designating the dialog form text from the external terminal, acquires the word concerning the dialog form text designated by the query, the time-series information of the word, and the identification information from the first database.

10. A dialog text summarization method comprising:
a process of a recognition result acquisition unit acquiring, from a first database, a word recognized from a dialog form text, time-series information of the word, and identification information identifying a speaker of the word; and
a process of a text summarization unit correcting the word based on the word, the time-series information of the word, the identification information, and a summarization model, and outputting a correction result to the first database.

11. The text summarization method according to claim 10, wherein the text summarization unit deletes a word determined to be not important by a determination using the summarization model.

12. The dialog text summarization method according to claim 10, wherein the text summarization unit deletes a word determined to be a recognition error by a determination using the summarization model.

13. The dialog text summarization method according to claim 10, wherein the text summarization unit corrects the word using a recurrent neural network in the summarization model.

14. The dialog text summarization method according to claim 10, wherein the text summarization unit displays the dialog form text including the correction result in such a way that a corrected portion and/or corrected content can be confirmed.

15. The dialog text summarization method according to claim 10, wherein a recognition unit executes a process of recognizing a word included in the dialog form text, a process of managing the time-series information for each of the recognized word, and a process of managing the identification information identifying the speaker of the word.
